(19) United States
(12) Patent Application Publication
(10) Pub. No.: US 2006/0149807 A1
(43) Pub. Date: Jul. 6, 2006

(54) METHOD OF REDUCING TIME TO DOWNLOAD A WEB PAGE

(76) Inventors: LIEN-CHUN DING, Taoyuan County (TW); CHING-KANG LEE, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/905,392

(22) Filed: Dec. 30, 2004

(51) Int. Cl. G06F 15/16

(52) U.S. Cl. 709/203; 709/217

(57) ABSTRACT

A method for reducing time to download a web page includes storing a web page and its expiry time, and checking if the web page is expired according to its expiry time after a client delivers a request to a server to download the web page. If the web page is not expired, the server will directly transmit the web page. If the web page is expired, the server will execute programs again to update the web page, and then transmit the updated web page.

### BACKGROUND OF INVENTION

1. Field of the Invention

The present invention relates to a method of reducing time to download a web page, and more particularly, a method of reducing time of large amount of algorithm calculation and large amount of accessing data from database.

2. Description of the Prior Art

With the arrival of the information age, the volume of information has increased tremendously. With the advent of early web pages composed with HTML (hypertext markup language), documents could be displayed by a client using a browser to decode the content of the web pages' HTML. However, the contents of these early web pages relied on the coding of the documents by a web designer, resulting in a static interface.

In the age of e-commerce, web pages are no longer simply a static frame with fixed images placed onto it. Users require more functions and hence the content of web pages has become more complicated. Different types of web-program languages have emerged, such as PHP (PHP: Hypertext Preprocessor), ASP (active server pages), JSP (Java Server Pages), etc. into e-commerce web pages. The main characteristic of these languages is that they are executed by the server and, most importantly, these programs connect to the database to access all types of historical and managed data to display the data as a web page for users to browse. Those skilled in the art will know that when one client requests a web page from a server, the server executes the program first and transmits the results to the client. Mostly the programs need to access data from database, but the access overhead is high and the amount of connections is limited. As the number of client increases, the number of connections may overload the capacity of the database.

To solve the above-mentioned problem, in order to design an active web site, and to lower the load of the server processing web sites, a method exists, invented by VIA Technologies Inc, Taiwan Patent 00594500, to reduce the load of servers processing web pages. The method is implemented by recording a server command and a client command in respective memory space of a specific web page to form specific index data. The specific index data allows the server to execute the server command directly, and output the results generated by the server command and the client command. Therefore, when the client sends out a request, the server takes time and resources to execute the server command to connect to and read the content of the database. When the requests of the client increase to a significant amount, the database becomes overloaded which affects the download speed of the web pages.

### SUMMARY OF INVENTION

It is therefore an objective of the claimed invention to provide a method for reducing time to download a web page to solve the above-mentioned problem.

According to the claimed invention, the method comprises storing a web page and its expiry time, and when requesting the web page from a server, the server checking whether the web page is expired according to the expiry time of the web page.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a diagram of a network system according to the present invention.

FIG. 2 illustrates a flowchart of a method for reducing time for the network system of FIG. 1 to download a web page.

### DETAILED DESCRIPTION

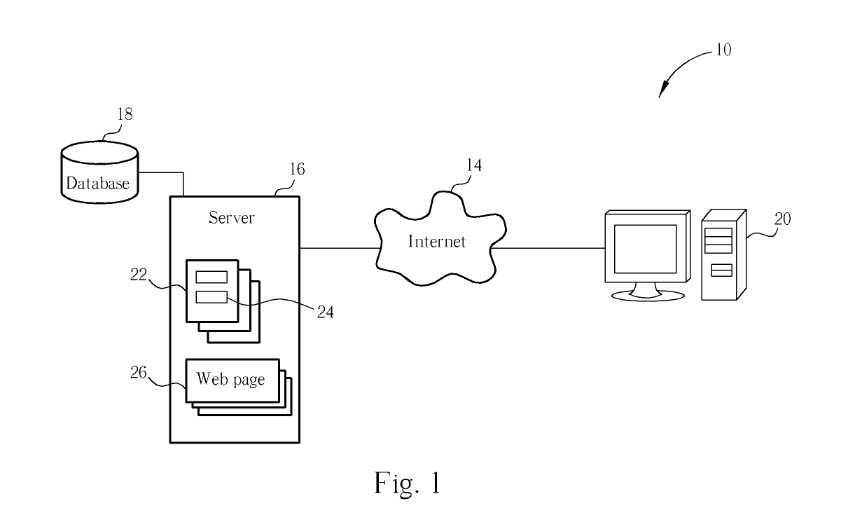

Please refer to FIG. 1, which illustrates a diagram of a network system 10 according to the present invention. The network system 10 comprises an Internet 14, a server 16 connected to the Internet 14, a database 18 and a client 20 connected to the internet 14. The server 16 comprises a plurality of web pages 26 and a plurality of programs 22, with each program 22 comprising a plurality of objects 24.

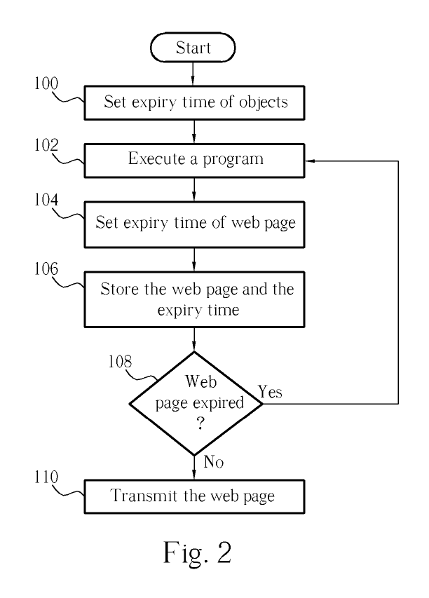

Please refer to FIG. 2, which illustrates a flowchart of the method for reducing time for the network system 10 to download a web page. The method comprises the following steps:

Step 100: set expiry time of a plurality of objects 24 of a program 22 and store the expiry time of the objects into database 18;

Step 102: execute the program 22 to generate a web page 26;

Step 104: the server 16 sets the expiry time of the web page 26 according to the earliest expiry time of a plurality of objects 24 of the program 22;

Step 106: store the web page 26 and the expiry time into the server 16;

Step 108: a client 20 sends out a request to the server 16 to read a web page 26; the server 16 checks whether the web page 26 has expired according to the expiry time of the web page 26; if the web page 26 has expired, the request sent out by the client 20 to the server 16 is retained and the process executes step 102; if the web page is not expired, step 110 is then executed;

Step 110: the server 16 transmits the web page 26 to the client 20.

To further explain the flowchart of FIG. 2 in combination with FIG. 1, the server 16 receives a request from the client to read a web page and if the web page is found to be expired; the request causes the server 16 to execute step 102 to update the web page and accordingly performs step 104, step 106 and step 108. After updating the web page 26, at step 108, the server 16 finds out that the web page 16 has not expired, after step 108, step 110 is executed thus completing the response to the request for the web page.

The above-mentioned steps and method are applicable to the modern e-commerce website. For example, for internet store operators, name, specification, image and price of a product are stored into the database. When the product is on sale for a period of time, the expiry time of the product information is set and stored into the database. If the product is on sale for a week, the client first sends a request to the server 16 to read a web page, the server executes part of the server command in the program to access the content of the database and the result is saved in the storage location. At the same time, the result from executing the program codes is transmitted to the client; after this action is completed, the client sends out a new request, the server accesses the content of the web page directly and transmits it to the client. Thus, there is no need to execute the server command or to connect to the database to access data. If the expiry time of the sale product has expired, the client sends a request again to verify and determine the expiry time of the web page, the server command of the program will update the web page by accessing new data from the database to be stored into the server, and the new web page will be transmitted to the client; after the server command is executed and the web page is stored in the server, JavaScript is collocated to allow the effect to display as designed, such that when members and non-members enter the website, different product prices or content will be displayed for each group.

The present invention can be utilized on a company's official website; when the company has a new announcement, according to the nature of the announcement, the company can decide on a release deadline and related information such as the detailed content, the announcement release unit, the announcement release deadline and any uploaded documents; these data can be stored into the database. The server searches for the earliest expiry time according to the same announcement release deadline of all the announcement information of the web page, and the earliest expiry time is set to be the expiry time. When a web page is not expired and the client sends a request to the server to read the document, the server can transmit the web page stored in the server directly to the client.

In comparison with the prior art, the present invention reduces the load of the server when processing web pages and, at the same time, reduces the number of times needed for connecting to and reading from the database and also reduces the load of connecting to the database caused by the prior art. The server determines the expiry time of the web page according to the data set by the web site designer, if the expired web page receives a request from the client, the content of the web page stored in the server will be updated accordingly. Therefore the present invention not only reduces the load of the server but also allows the client to receive new information.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of reducing time to download a web page comprising the following steps:
(a) storing a web page and an expiry time of the web page; and
(b) when requesting the web page from a server, the server checking whether the web page is expired according to the expiry time of the web page.

2. The method of claim 1 further comprising:
when a result in step (b) shows that the web page is not expired, the server downloading the web page.

3. The method of claim 1 further comprising the following step:
(c) executing program codes to generate the web page.

4. The method of claim 3 further comprising:
when a result in step (b) shows that the web page is expired, repeating step (c).

5. The method of claim 1 further comprising setting expiry times of a plurality of objects of the program codes, and storing the expiry times in the database.

6. The method of claim 5 further comprising the server setting the expiry time of the web page according to an earliest expiry time of the objects of the program codes.
